(19) United States
(12) Patent Application Publication
(10) Pub. No.: US 2010/0044904 A1
(43) Pub. Date: Feb. 25, 2010

(54) Method of creating decorative wood

(76) Inventors: Yuri Udovik, Trevose, PA (US); Oleg Udovik, Trevose, PA (US)

Correspondence Address: Yuri Udovik, 4433 Somerton Road, Trevose, PA, 19053, US

(21) Appl. No.: 12/229,336

(22) Filed: Aug. 22, 2008

(51) Int. Cl. B29C 59/08

(52) U.S. Cl. 264/80

(57) ABSTRACT

The method of creating decorative wood consists of deep firing of the wood surface with the following removal/cleaning of slag. The procedure of firing in this particular case would consist of the use of propane torch or any other source of fire that can be used for working with a top layer of wood. The removal/cleaning procedure would include the manual use of metal brush, or any other source of mechanical way of slag removal. The decorative wood doesn't need any necessary addition of coloring and may be finished with varnish, oil or other finishing material. Such method provides an opportunity to feel the texture with bare hands, and not only what is visually perceived with a human eye.

### BACKGROUND OF THE INVENTION

1. Field of the Invention

The present invention relates generally to woodworking technique. It relates to creating a decorative wood with the result of a textural relief without any necessary addition of coloring. Such method provides an opportunity to feel the texture with bare hands, and not only what is visually perceived with a human eye.

2. Description of Related Art

There are many techniques, both traditional and modern, for creating various types of decorative woods. Stained wood is a good example of decorative wood. It is used in industries such as furniture, windows and doors, hardwood floor and many other types of similar industries that people are using exteriorly and interiorly.

This particular invention is devoted to a new brilliant way to find an alternative to the common fashion of decorating a home, office, or any place that is asking for style, sharpness, or simply an up-dated modern look.

### SUMMARY

Method of creating decorative wood contains procedures as described below. The procedures of such method consist of: 1) selecting a piece of wood; 2) securing the wood to a leveled surface in the place safe of fire; 3) deep firing of the wood surface; 4) removal/cleaning of slag; 5) applying varnish, oil or other wood finishers for the final touch. The procedure of firing, in this given case, would consist of use of propane torch or any other source of fire that can be used for working with a top layer of wood, for example kiln, furnace. The slag removal procedure would include the use of any metal brush manually, or use of wire wheel brush or sandblaster mechanically. The applying of wood finishers would include the use of a paintbrush or sprayer. Such method provides an opportunity to feel the texture with bare hands, and not only what is visually perceived with a human eye.

The metal brush technique chosen would be used to create a color of relief desired, as in drawing. For example, using more pressure/force on the brush would create a lighter color of relief, whereas less pressure/force would create a darker color of relief as a result. The combination of pressure/force alternation would provide a more creative and classic look from light to dark brightness.

The result is a textural relief without any necessary addition of coloring. Such surface is predisposed to sun light and can be used for decorative purpose inside and outside door. This method is suitable for any kind of wood; however a pine tree is considered the most common and best material to exhaust texture and color.

### DESCRIPTION OF THE DRAWINGS

FIG. 1 illustrates a front-side perspective view of the chosen wood according to one embodiment of an aspect of the invention.

FIG. 2 illustrates a front-side perspective view of the chosen wood with continuation of firing procedure by using propane torch according to one embodiment of an aspect of the invention.

FIG. 3 illustrates a front-side perspective view of the chosen wood with already fired/burned top layer with continuation of slag cleaning/removal procedure by using metal brush according to one embodiment of an aspect of the invention.

FIG. 4 illustrates a front-side perspective view of the chosen wood after slag cleaning/removal procedure with continuation of applying wood finishers according to one embodiment of an aspect of the invention.

FIG. 5 illustrates a front-side perspective view of the ready decorative wood with textural relief according to one embodiment of an aspect of the invention.

### DETAILED DESCRIPTION OF THE INVENTION

The present invention is simplified to show elements that go in accordance with the procedure to gain a clear understanding of this specific invention. Substitution and elimination of other elements is used for the purpose of clarity. Those who are working within this art might recognize that other elements are desirable and/or required in order to implement the present invention. However, because such elements are well known in the art, and because they do not facilitate a better understanding of the present invention, a discussion of such elements is not provided herein. The detailed description will be provided herein below with reference to the attached drawings.

This methodology reflects at least one exemplary embodiment for creating aesthetically pleasing wood looks according to the present invention. Although several alternatives for each step in the method and each tool or other material are described, one skilled in the art could further extend the described embodiments within the teaching of the present disclosure. As such, the various embodiments described below, which are detailed with reference to the attached drawings, are exemplary in nature and should not be construed to limit any further claims drawn to the present subject matter in any way.

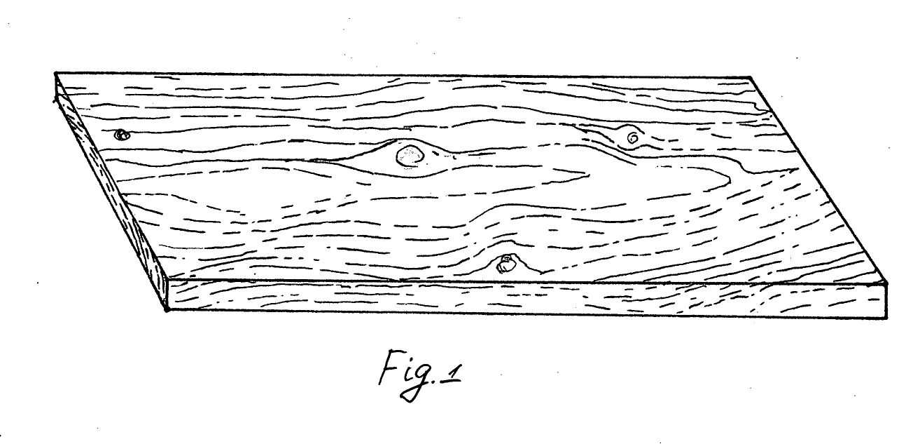

A preferred woodworking technique according to the present invention will now be described with respect to the following steps. Initially, (Step 1) the wood decorative method is preferably employed using a piece of porous wood of any shape or size as shown on FIG. 1. The desired outcome of the artwork is the determining factor when selecting the wood kind and size. For example, any of a variety of wood kinds may be used including pine (soft), poplar (soft), oak (hard), birch (hard), or other porous woods.

(Step 2) After selecting the appropriate wood, clamps or other forms of vices are used to secure the wood to a leveled surface in the place safe of fire for further processing.

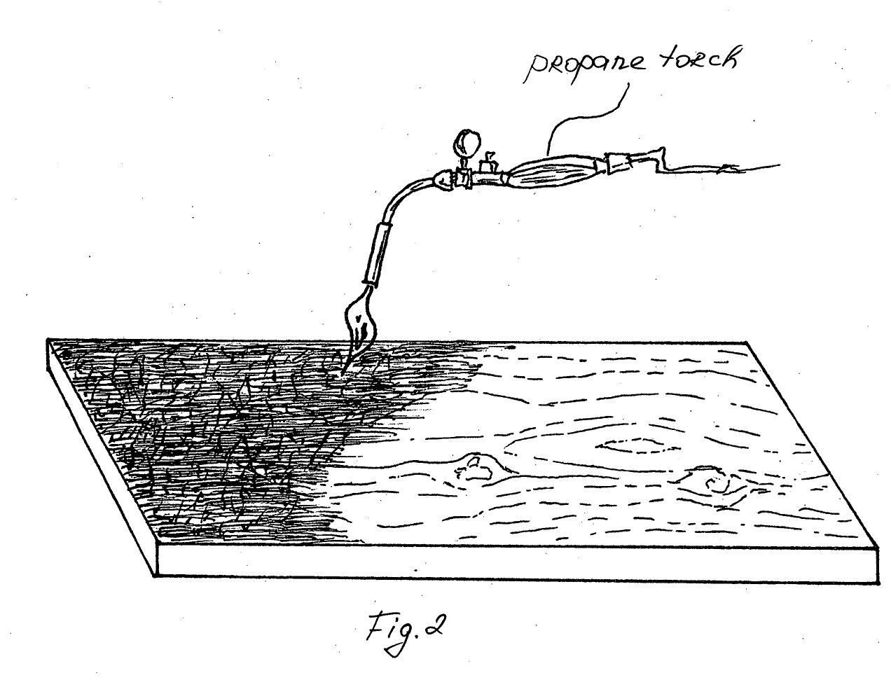

(Step 3) After placing the wood start the firing procedure of the top layer on at least one, or more preferably both, broad face(s) of the wood as shown on FIG. 2. The procedure of firing would consist of use of propane torch or any other source of fire that can be used for working with a top layer of wood, for example kiln, furnace. In one embodiment, the top layer of the wood is deeply burned until the numerous amounts of cracks are appearing on the surface of the wood and that will be the sign for stopping a firing procedure.

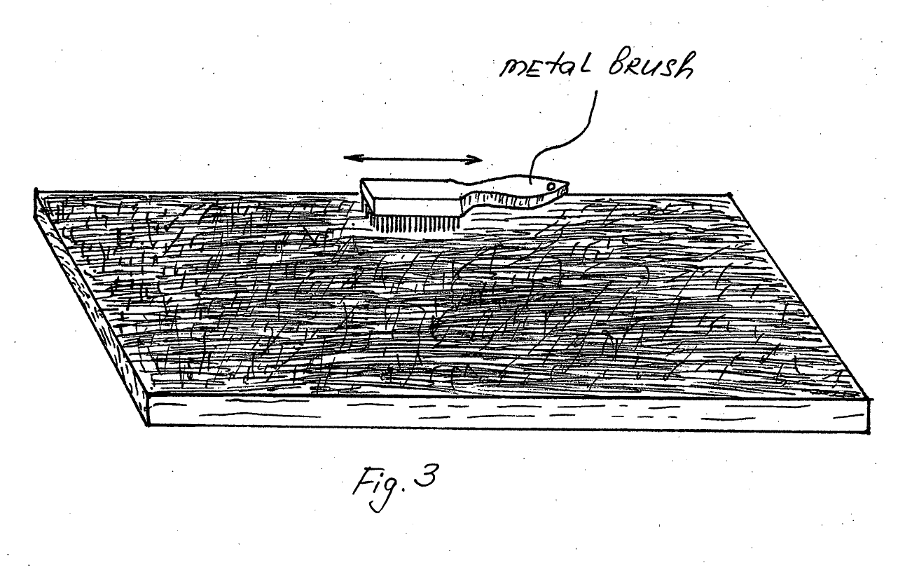

(Step 4) After firing procedure, start the slag cleaning/removal procedure as shown on FIG. 3. Repeatedly moisturize the burned layer in order not to get to much dust during the slag cleaning/removal procedure. Perform this cleaning/removal procedure manually by using metal brush where we reinforce the pressure along the wood with back and force movement. The metal brush technique chosen would be used to create a color of relief desired. For example, using more pressure/force on the brush would create a lighter color of relief, whereas less pressure/force would create a darker color of relief as a result. The combination of pressure/force alternation would provide a more creative and classic look from light to dark brightness. Also we could use the mechanical way for slag removal by using wire wheel brush machine or sandblaster.

The outcome of the textural relief and color specter is based on the fact that wood surface has 2 parts/divisions: hard and soft. In order to gain a full understanding of what soft and hard divisions of the wood are, one might use a piece of tree that was diagonally cut at the trunk as a perfect example. When a piece of wood is cut diagonally, it allows one to see circles and a space between them. Often, those circles are used to figuring out the age of the tree by counting them, as any forest-guard would evidence. Therefore, the hard part is referred to the circles themselves and the soft part is simply the space that is between any two circles. The soft part burns easier and faster than the hard part which forms dark ridges and light valleys after the cleaning procedure. Also, the color spectrum changes from darker on the ridges to lighter on the valleys.

(Step 5) After cleaning/removal of slag procedure the surface of the wood should be cleaned of all dirt, dust or slag in preparation for the wood varnishing process described below. Clean the entire wood surface by using a hand brush or the vacuum cleaner.

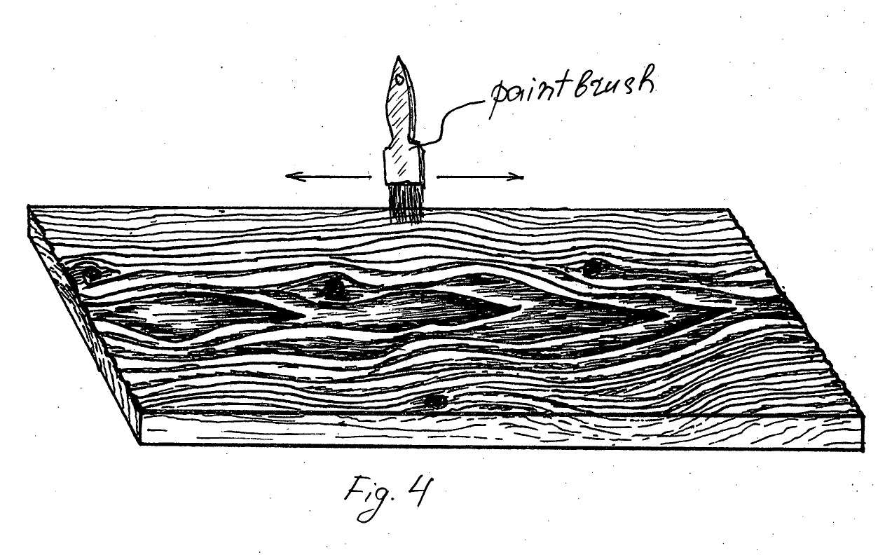

Upon the removal of all dirt, dust and slag of the woodwork, applying of oils or varnish to the wood should follow (Step 6). The wood can also be treated with a wood sealer to provide a more even absorption of varnish. The oils or varnish are preferably applied using a paintbrush or a sprayer. Oils, and/or varnishes are preferably applied in the direction of the wood grains as indicated on FIG. 4. The varnish or other wood finishing material is then allowed to dry for approximately up to 24 hours, depending on size of wood work and room temperature, or as directed by the manufacturer's directions on the label of the oil or varnish that is used. You could repeat (Step 6) as to increase coating for desired results.

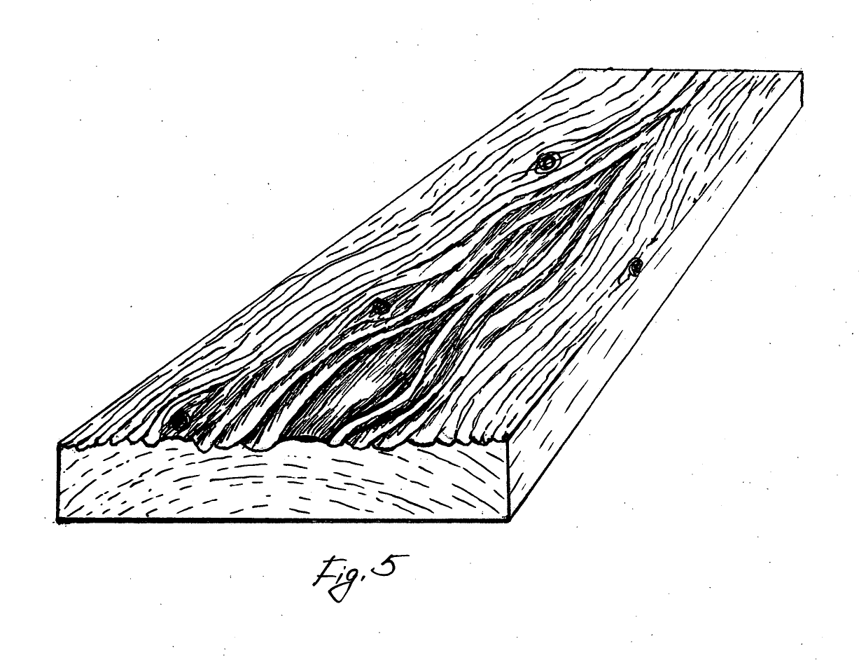

(Step 7) After completing the final finishing and allowing it to dry according to the effect desired for the wood, the entire piece should be wiped down using a tack cloth to remove all the dirt, dust or debris. The resulted piece of woodwork is indicated on FIG. 5.

As described above, this method may be used to create a unique aesthetically pleasing look of decorative wood. In general, common tools are used such as: clamps, slag removal tools (metal brush, wire wheel brush or sandblaster), wood firing elements (propane torch, kiln or furnace), oils, varnishes, dry cloths or rags, paintbrushes, and any piece of selected wood are used.

There is no limitation to the present invention in relation to any specific materials, geometry, or orientation of elements. The substitution is contemplated within the scope of the present invention and will be apparent to those skilled in the art. The embodiments described herein were presented by way of example only and should not be used to limit the scope of the invention.

Additional embodiments and modifications without departing from the spirit of, or exceeding the scope of, the claimed invention can be generated. Accordingly, it is understood that the drawings and the descriptions herein are proffered only to facilitate comprehension of the invention and should not be construed to limit the scope thereof

What is claimed is:

1. A method for creating decorative wood, comprising the steps of selecting a piece of wood; securing the wood to a leveled surface in a place safe from fire; burning the surface of the wood until an aPpearance of visible cracks; removing of slag, after burning procedure, until the results of wood grain texture and color are visible; applying wood finishers.

2. The method of claim 1, wherein said piece of wood is selected from any kind of wood.

3. The method of claim 2, wherein said piece of wood is selected by size and structure, by presence or absence of knocks, by horizontal or vertical cut of the tree.

4. The method of claim 1, wherein said securing is accomplished by using clamps or vices.

5. The method of claim 1, wherein said burning is accomplished by using propane torch.

6. The method of claim 1, wherein said burning is accomplished by using kiln or furnace.

7. The method of claim 1, wherein said removing of slag is accomplished by using metal brush manually.

8. The method of claim 1, wherein said removing of slag is accomplished by using wire wheel brush mechanically.

9. The method of claim 1, wherein said removing of slag is accomplished by using sandblaster.

10. The method of claim 1, wherein said wood finishing material is a varnish or tung oil.
